(19) United States
(12) Patent Application Publication
(10) Pub. No.: US 2026/0195546 A1
(43) Pub. Date: Jul. 9, 2026

(54) APPARATUS FOR GENERATING FEATURE VECTOR, METHOD, AND STORAGE MEDIUM

(71) Applicant: KABUSHIKI KAISHA TOSHIBA, Kawasaki-shi Kanagawa (JP)

(72) Inventors: Yasutoyo TAKEYAMA, Kawasaki Kanagawa (JP); Atsushi YAGUCHI, Tokyo (JP); Ryusuke HIRAI, Tokyo (JP)

(73) Assignee: KABUSHIKI KAISHA TOSHIBA, Kawasaki-shi Kanagawa (JP)

(21) Appl. No.: 19/439,798

(22) Filed: Jan. 5, 2026

(30) Foreign Application Priority Data
Jan. 6, 2025 (JP) 2025-001888

(51) Int. Cl. G06F 40/40; G06Q 30/0601

(52) U.S. Cl. CPC G06F 40/40; G06Q 30/06311

(57) ABSTRACT

According to one embodiment, a processor inputs attribute information that is entity information of an attribute category. The processor inputs an intermediate feature category related to an intermediate feature capable of being associated with an estimation target that is associated with the attribute information and is entity information of an estimation target category. The processor generates a prompt representing a question sentence based on the intermediate feature category and the attribute information. The processor applies the prompt to an answer sentence generative model to generate an answer sentence predicting the intermediate feature. The processor converts the answer sentence into a feature vector.

### CROSS-REFERENCE TO RELATED APPLICATION

This application is based upon and claims the benefit of priority from Japanese Patent Application No. 2025-001888, filed January 6, 2025, the entire contents of which are incorporated herein by reference.

### FIELD

Embodiments described herein relate generally to an apparatus for generating feature vector, a method, and a storage medium.

### BACKGROUND

Recently, development of large language models (LLM) is remarkable, and not only technological progress of LLM itself but also development of a method for applying LLM to technologies in other fields is active. A method of applying LLM has also been developed in a recommendation system technology used to recommend an item to a shopper or a social networking service (SNS) user. There is a plurality of application methods of LLM in the recommendation system, and one of them is feature vector calculation. In the recommendation system, a method of graph deep learning or machine learning using a transformer is used. It is possible to improve the recommendation accuracy of the recommendation system technology by generating a feature vector representing the feature of the user or the item using the LLM as the input of these technologies.

However, there is an issue that it is difficult to create a prompt to make an input to LLM to generate the feature vector. For example, in generating a feature vector, it is common to perform processing of causing an LLM to answer regarding features of a user or an item with a text. At this time, the way to create a prompt to make an input to the LLM affects the success or failure of the subsequent recommendation system. However, there is no general-purpose method for creating the prompt.

As another example, when a recommendation system is applied to a real problem, data that can be used for each problem is often different. Since the prompt to make an input to the LLM needs to be changed according to the type of data that can be used, the designer needs to create an appropriate LLM for each problem, and the creation difficulty is high.

Non-Patent Literature 1 (Yunjia Xi, Weiwen Liu, Jianghao Lin, Jieming Zhu, Bo Chen, Ruiming Tang, Weinan Zhang, Rui Zhang, and Yong Yu. “Towards open-world recommendation with knowledge augmentation from large language models”. arXiv preprint arXiv:2306.10933, 2023.) is a method of generating a prompt for each of a user and an item and generating a feature vector, but the prompt is generated on the assumption that there is attribute information such as an age, a gender, an occupation, a purchase history, and a feature of a preferred item of the user as usable data. However, the Non-Patent Literature 1 does not indicate a method of generating a prompt in a case where attribute information cannot be obtained or in a case where another attribute information can be used.

### BRIEF DESCRIPTION OF DRAWINGS

FIG. 1 is a diagram showing a configuration example of an information processing apparatus according to a first embodiment.

FIG. 2 is a diagram showing a configuration example of an association graph.

FIG. 3 is a diagram showing an example of a process of estimating a product to be purchased in future by the information processing apparatus according to the first embodiment.

FIG. 4 is a diagram schematically showing an example of a process of estimating a product to be purchased in future shown in FIG. 3.

FIG. 5 is a diagram showing an example of a display screen of an estimation target.

FIG. 6 is a diagram schematically showing differences in attribute information among a plurality of users (USER A, B, C, and D) and a fact that intermediate features are common regardless of the differences.

FIG. 7 is a diagram for comparing estimation accuracy (recall) between the method according to the first embodiment and the method according to a comparative example.

FIG. 8 is a diagram showing a configuration example of an information processing apparatus according to a second embodiment.

FIG. 9 is a diagram showing an example of recording process of estimation accuracy for each intermediate feature category set by the information processing apparatus according to the second embodiment.

FIG. 10 is a diagram showing a set table related to the association graph shown in FIG. 2.

FIG. 11 is a diagram showing an example of a set table in which estimation accuracy is recorded.

FIG. 12 is a diagram showing a configuration example of an information processing apparatus according to a third embodiment.

FIG. 13 is a diagram showing an example of recording process of estimation accuracy for each answer sentence generative model by the information processing apparatus according to the third embodiment.

FIG. 14 is a diagram showing a model table.

FIG. 15 is a diagram showing an example of a model table in which estimation accuracy is recorded.

### DETAILED DESCRIPTION

The apparatus for generating feature vector according to an embodiment includes an attribute input unit, an intermediate feature input unit, a question generation unit, an answer sentence generation unit, and a conversion unit. The attribute input unit inputs attribute information that is entity information of an attribute category related to a process target. The intermediate feature input unit inputs at least one intermediate feature category related to an intermediate feature that can be associated with an estimation target that is associated with the attribute information and is entity information of the estimation target category. The question generation unit generates a prompt indicating a question sentence to an answer sentence generative model regarding the intermediate feature category based on the intermediate feature category and the attribute information. The answer sentence generation unit applies the prompt to the answer sentence generative model to generate an answer sentence predicting the intermediate feature. The conversion unit converts the answer sentence into a feature vector.

Hereinafter, an information processing apparatus, a method, and a program according to the present embodiment will be described with reference to the drawings. The information processing apparatus according to the present embodiment is a computer provided in a computer network system that recommends an item to a user, to which a large language model (hereinafter, LLM) is applied. Here, the user is a person who has purchased a certain product, the item is a product, and the item to be recommended means a product to be purchased by the user in the future (hereinafter, product to be purchased in future).

### First Embodiment

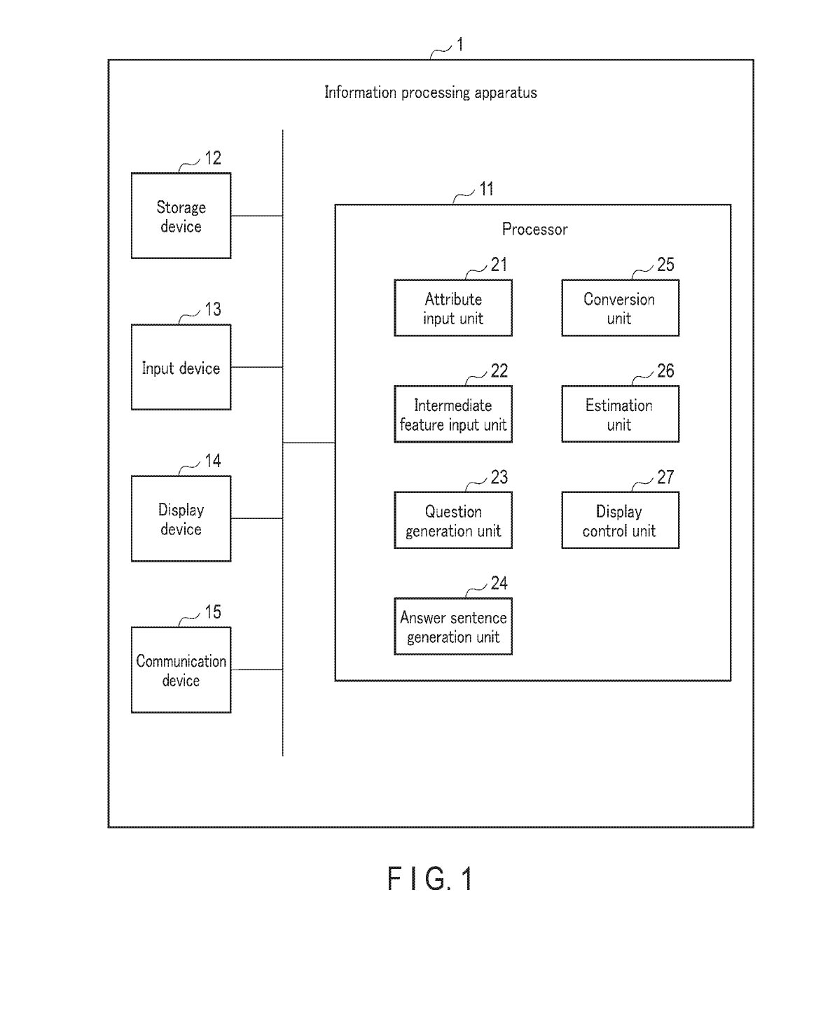

FIG. 1 is a diagram showing a configuration example of an information processing apparatus 1 according to a first embodiment. As shown in FIG. 1, the information processing apparatus 1 is a computer including a processor 11, a storage device 12, an input device 13, a display device 14, and a communication device 15. Transmission and reception of data and various signals between the processor 11, the storage device 12, the input device 13, the display device 14, and the communication device 15 are performed via a bus.

The processor 11 is an integrated circuit that controls the entire operation of the information processing apparatus 1. For example, the processor 11 includes a central processing unit (CPU), a graphics processing unit (GPU), a digital signal processor (DSP), and/or a floating-point unit (FPU). The processor 11 may include an internal memory or an I/O interface. The processor 11 executes various processes by interpreting and calculating a program stored in advance by the storage device 12, or the like. Additionally, a part or the whole of the processor 11 may be realized by hardware such as an application specific integrated circuit (ASIC) or a field programmable gate array (FPGA).

The storage device 12 is a volatile memory and/or a nonvolatile memory that stores various data. For example, the storage device 12 stores data and setting values used when the processor 11 executes various processes, data generated by various processes in the processor 11, and the like. The storage device 12 includes a read only memory (ROM), a random access memory (RAM), a hard disk drive (HDD), a solid state drive (SSD), an integrated circuit storage device, and the like. Note that the storage device 12 may include a non-transitory computer readable storage medium that stores the program executed by the processor 11.

The input device 13 receives inputs of various operations from an operator. As the input device 13, a keyboard, a mouse, various switches, a touch pad, a touch panel display, and the like can be used. The operation signal corresponding to the input of the received operation is supplied to the processor 11.

The display device 14 displays various data under the control of the processor 11. As the display device 14, a cathode-ray tube (CRT) display, a liquid crystal display, an organic Electro Luminescence (EL) display, a Light-Emitting Diode (LED) display, a plasma display, or any other display can be appropriately used. The display device 14 may be a projector.

The communication device 15 includes a communication interface such as a network interface card (NIC) for performing data communication with various devices connected to the information processing apparatus 1 via a network. Note that an operation signal may be supplied from a computer connected via the communication device 15 or an input device included in the computer, or various data may be displayed on a display device or the like included in the computer connected via the communication device 15. However, in order to simplify the following description, unless otherwise specified, it is assumed that the supply source of the operation signal is the input device 13 and the display destination of various data is the display device 14. The input device 13 can be replaced with a computer connected via the communication device 15 or an input device included in the computer, and the display device 14 can be replaced with a display device or the like included in the computer connected via the communication device 15.

The information processing apparatus 1 does not necessarily include all of the processor 11, the storage device 12, the input device 13, the display device 14, and the communication device 15. If necessary, some of the storage device 12, the input device 13, the display device 14, and the communication device 15 are not necessarily provided. The information processing apparatus 1 may be provided with any additional hardware device useful for executing the process according to the present embodiment. The information processing apparatus 1 does not need to be physically configured by one computer and may be configured by a computer system including a plurality of computers communicably connected via a wired or network line or the like. The allocation of the series of processes according to the present embodiment to the plurality of processors 11 mounted on the plurality of computers can be arbitrarily set. All the processors 11 may execute all the processes in parallel, or a specific process may be assigned to one or some of the processors 11, and a series of processes according to the present embodiment may be executed as the entire computer system.

As shown in FIG. 1, the processor 11 includes an attribute input unit 21, an intermediate feature input unit 22, a question generation unit 23, an answer sentence generation unit 24, a conversion unit 25, an estimation unit 26, and a display control unit 27.

The attribute input unit 21 inputs attribute information that is entity information of an attribute category related to a process target. The process target means a user or a product as a generation target of the feature vector generated by the conversion unit 25. The attribute category is a category of the attribute information. For example, in a case where the process target is a user, the attribute categories are an age, a gender, a family structure, an annual income, an occupation, a product the user purchased in the past (hereinafter, a product purchased in the past), or the like. In a case where the process target is a product, the attribute categories are a name, a manufacturing company, a manufacture date, a sales company, or the like. The attribute information means entity information of the attribute category, that is, specific information. For example, the attribute information of the attribute category “product purchased in the past” of a certain user is a specific product name such as “AA beer” or “BB newspaper.”

The intermediate feature input unit 22 inputs at least one intermediate feature category related to an intermediate feature that can be associated with an estimation target that is associated with the attribute information and is entity information of the estimation target category. Specifically, the intermediate feature input unit 22 inputs an association graph related to the estimation target category, and extracts the intermediate feature category from the association graph. The number of extracted intermediate feature categories is one or more.

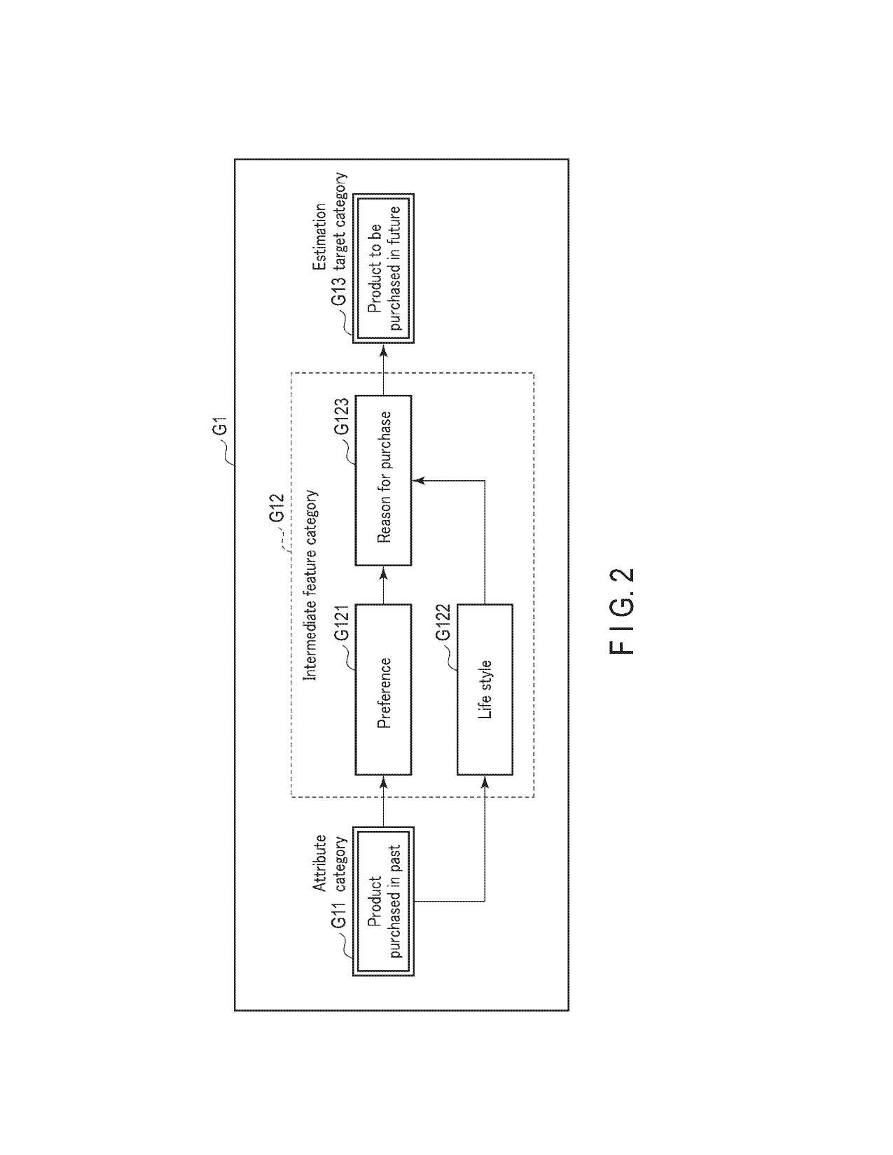

FIG. 2 is a diagram showing a configuration example of an association graph G1. As shown in FIG. 2, the association graph G1 is a directed graph representing a path of association between the categories from the attribute category to the estimation target category via the intermediate feature category. Specifically, the association graph G1 includes a start point node G11 corresponding to the attribute category, an end point node G13 corresponding to the estimation target category, and an intermediate node G12 corresponding to the intermediate feature category. Nodes having an associative relationship among the start point node G11, the end point node G13, and the intermediate node G12 are connected by an edge. In FIG. 2, the edge is represented by an arrow. It is evoked from the category at the base of the arrow toward the category at the tip (arrowhead). It is designed so that the end point node G13 can be reached by following any path from the start point node G11. An intermediate feature is associated with the attribute information, and an estimation target is associated with the intermediate feature. The intermediate feature can be said to be useful information for estimating the estimation target in the association graph.

As an example, the association graph G1 shown in FIG. 2 indicates the association graph when the process target is the user and the estimation target category is the “product to be purchased in future”. The attribute category is “product purchased in the past”, and “preference” that is an intermediate node G121 and “lifestyle” that is an intermediate node G122 are intermediate feature categories directly associated with the “product purchased in the past”, and “reason for purchase” that is an intermediate node G123 is an intermediate feature category directly associated with the “preference” and “lifestyle”. The “product to be purchased in future” that is the estimation target category is directly associated with the “reason for purchase”. In other words, the input side of the intermediate node G121 corresponding to the “preference” and the input side of the intermediate node G122 corresponding to the “lifestyle” are connected in parallel to the output side of the start point node G11, the input side of the intermediate node G123 corresponding to the “reason for purchase” is connected in parallel to the output side of the intermediate node G121 corresponding to the “preference” and the output side of the intermediate node G122 corresponding to the “lifestyle”, and the input side of the end point node G13 corresponding to the “product to be purchased in future” is connected to the output side of the intermediate node G123 corresponding to the “reason for purchase”.

The question generation unit 23 generates a prompt indicating a question sentence to the answer sentence generative model regarding the intermediate feature category based on the intermediate feature category input by the intermediate feature input unit 22 and the attribute information input by the attribute input unit 21. The answer sentence generative model is an example of the large language model (LLM).

The answer sentence generation unit 24 applies the prompt generated by the question generation unit 23 to the answer sentence generative model to generate an answer sentence predicting the intermediate feature. The answer sentence generative model is a machine learning model trained to input a prompt and output a text corresponding to an answer sentence to the prompt. In a case where there is a plurality of intermediate feature categories, an answer sentence is generated for each intermediate feature category. The answer sentence generative model is an example of the large language model.

The conversion unit 25 converts the answer sentence generated by the answer sentence generation unit 24 into a feature vector. The feature vector directly means a vector of the answer sentence. The feature vector can also be expressed as a vector numerically expressing an attribute or a feature specific to the process target.

The estimation unit 26 estimates an estimation target based on the feature vector generated by the conversion unit 25. The estimation target may be any information that can be estimated by the feature vector, but in the case of FIG. 2, the estimation target is a product to be purchased in future of the user. In this case, the estimation unit 26 applies the feature vector to a product estimation model and outputs a text representing a product to be purchased in future which is the estimation target.

The display control unit 27 displays various types of information on the display device 14. For example, the display control unit 27 displays the prompt generated by the question generation unit 23 and the answer sentence generated by the answer sentence generation unit 24 on the display device 14 in an interactive manner. At this time, the display control unit 27 may emphasize the text corresponding to the attribute information and the text corresponding to the intermediate feature category which are included in the prompt with different visual effects. As another example, the display control unit 27 may display the association graph side by side with the prompt and the answer sentence.

Next, an example of a process of estimating a product to be purchased in future by the information processing apparatus 1 according to the first embodiment will be described.

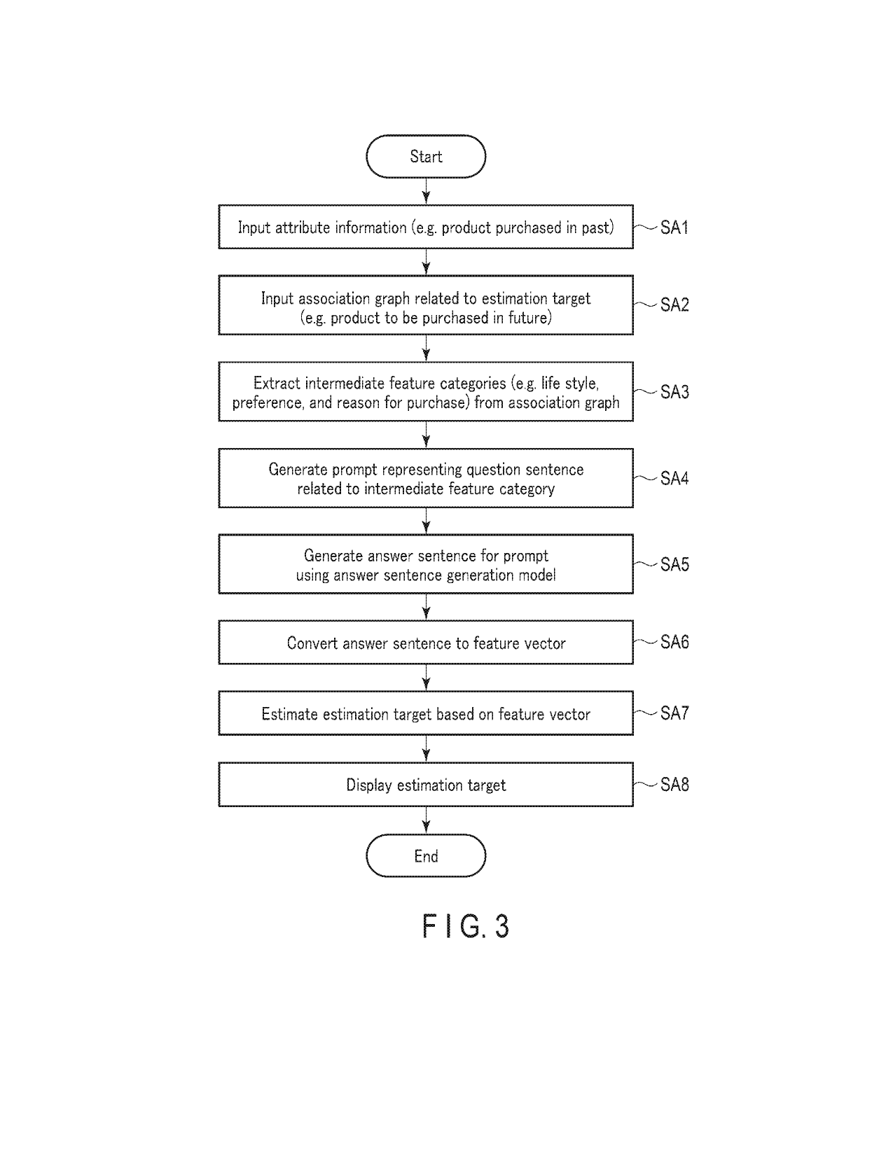

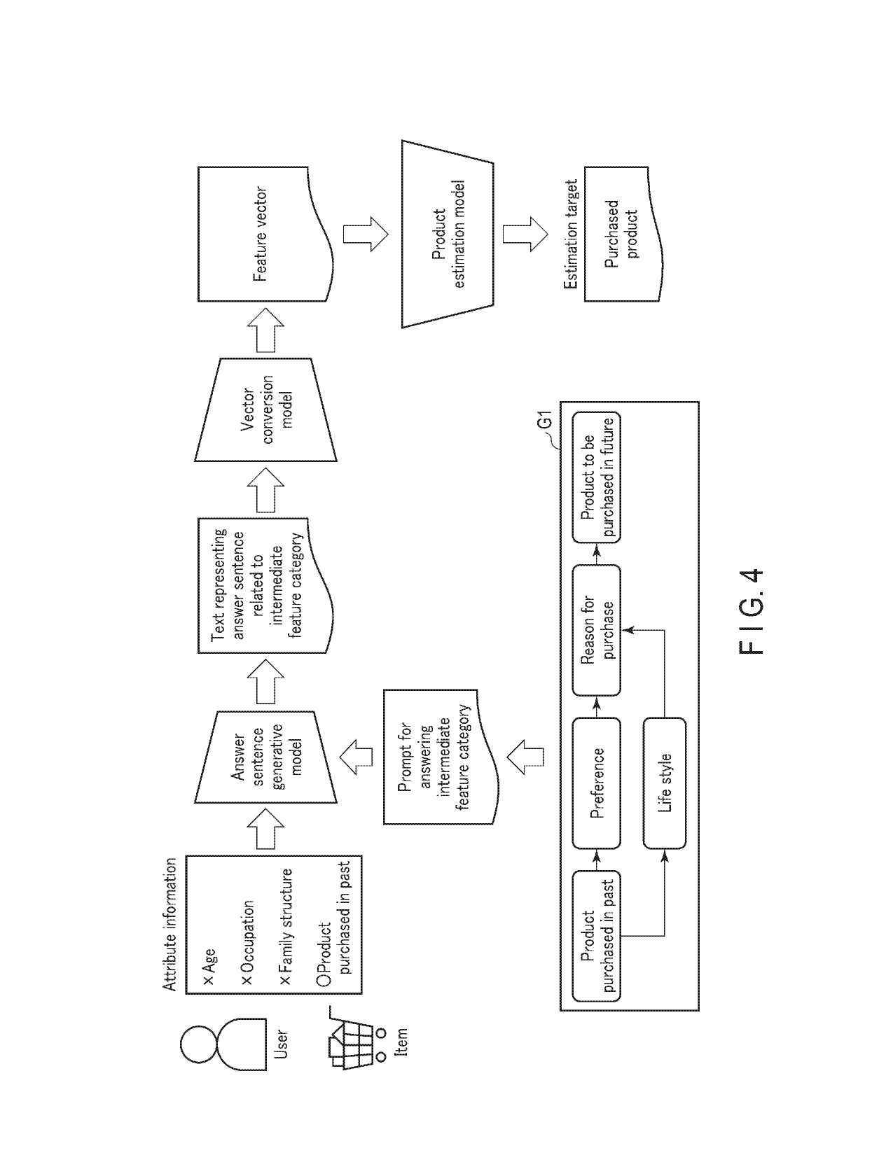

FIG. 3 is a diagram showing an example of a process of estimating a product to be purchased in future by the information processing apparatus 1 according to the first embodiment. FIG. 4 is a diagram schematically showing an example of a process of estimating a product to be purchased in future shown in FIG. 3. Note that, in FIGS. 3 and 4, it is assumed that a process target is a user.

As shown in FIG. 3, the attribute input unit 21 inputs attribute information regarding the target user (step SA1). The attribute category of the input attribute information can be arbitrarily selected from a plurality of predetermined specific categories such as age, occupation, family structure, products purchased in the past, and the like. A method of inputting the attribute information is not particularly limited. For example, in a case where attribute information of a large amount of users is recorded in a database, and a product to be purchased in future of the user stored in the database is estimated, the attribute input unit 21 searches the database using identification information of the user as a keyword, and extracts attribute information associated with the keyword. In this case, it is assumed that part of the attribute information of the attribute category is missing. In the case of FIG. 4, the age, occupation, and family structure are missing, and only the product purchased in the past is input. Note that the attribute information may be manually input by the operator via the input device 13.

Once step SA1 is performed, the intermediate feature input unit 22 inputs an association graph related to the estimation target (step SA2). Specifically, each of association graphs corresponding to each of estimation targets is stored in advance in the storage device 12. The intermediate feature input unit 22 extracts an association graph corresponding to an estimation target specified by the input device 13 or the like from the storage device 12. Note that the association graph may be manually input by the operator via the input device 13.

Once step SA2 is performed, the intermediate feature input unit 22 extracts the intermediate feature categories from the association graph input in step SA2 (step SA3). As an example, the intermediate feature input unit 22 excludes the attribute category and the estimation target category from the association graph and extracts the remaining intermediate feature categories. For example, in the case of the association graph of FIG. 4, the intermediate feature categories “preference”, “lifestyle”, and “reason for purchase” are extracted excluding the attribute category “product purchased in the past” and the estimation target category “product to be purchased in future”.

Once step SA3 is performed, the question generation unit 23 generates a prompt representing a question sentence to the answer sentence generative model related to the intermediate feature category extracted in step SA3 (step SA4). In step SA4, the question generation unit 23 generates a prompt for causing the answer sentence generative model to answer the intermediate feature categories based on the attribute information and the intermediate feature categories. As an example, a fixed phrase, into which a first program variable of attribute information and a second program variable of an intermediate feature category are inserted, for estimating the intermediate feature category from the attribute information is created in advance and stored in the storage device 12. The question generation unit 23 reads the fixed phrase from the storage device 12, substitutes a text corresponding to the attribute category of the attribute information input in step SA1 to the first program variable, substitutes a text corresponding to the attribute information input in step SA1 to the second program variable, and substitutes a text corresponding to the intermediate feature category extracted in step SA3 to the third program variable, thereby generating a prompt. For example, in a case where the attribute category is “product purchased in the past” and the intermediate feature category is three types of “preference”, “lifestyle”, and “reason for purchase”, the prompt is as follows. In the following prompt, “” is data substituted into the first program variable, [] is data substituted into the second program variable, and <> is data substituted into the third program variable. Information specific to the target user is input as the attribute information.

The “product purchased in the past” of a certain user is [grilled chicken for ready-made hot foods, AA-free alcoholic beverages, drink fee for cafe and eating-out (in store), BB for energy drinks and health foods, payment for tea and eating-out (in store), CC newspaper, Oolong tea Chu-hi for alcoholic beverages, tax-exempt medical and hygiene fee, lettuce for fresh vegetables and fruits, shopping fee for other foods]. Answer the following question about this user. Attach a question number to the answer to each question.

Question No. 1: Predict this user's <lifestyle>.

Question No. 2: Predict this user's <preference>.

Question No. 3: Predict this user’s <reason for purchase>.

Once step SA4 is performed, the answer sentence generation unit 24 generates an answer sentence to the prompt generated in step SA4 using LLM (step SA5). In the answer sentence generative model, a plurality of prompts corresponding to question sentences related to a plurality of intermediate feature categories may be input at a time or may be input one by one. Correspondingly, from the answer sentence generative model, a plurality of answer sentences related to a plurality of intermediate features may be output at a time, or a plurality of answer sentences may be output one by one. In the above example of the prompt, the following answer sentences are output from the answer sentence generative model.

Question No. 1: Since this shopper obtains fresh food, cooked food, alcohol, health food, and newspaper, it can be predicted that there is a certain amount of time to enjoy the shopper’s own life. In addition, since the shopper has purchased medical and hygiene products, the shopper may be conscious of the shopper’s own health. However, since he/she frequently uses cafes and restaurants, he/she seems to have a busy lifestyle and may be unable to spend enough time on cooking at home.

Question No. 2: This shopper seems to particularly like alcoholic beverages (the shopper has purchased AA beer and Oolong tea Chu-hi). In addition, since the shopper purchased various kinds of foods such as grilled chicken and lettuce, it is expected that the shopper enjoys those foods. It can be seen that the shopper is interested in healthy eating and drinking because the shopper has purchased green juice of health food. Then, since the shopper reads the BB newspaper, there is a possibility that the shopper finds value in collecting information through the newspaper.

Question No. 3: The reason for purchase is considered to be to prepare daily necessities needed at home, take meals, and enjoy relaxation and entertainment. Alcohol and grilled chicken are part of relaxation and enjoyment at home, and lettuce and green juice contribute to healthy eating and drinking. Furthermore, it can be predicted that eating-out and purchase of newspapers indicate interest in the world around him/her and effective use of meal time.

Once step SA5 is performed, the conversion unit 25 converts the answer sentences generated in step SA5 into feature vectors (step SA6). A method for converting the answer sentences into the feature vectors is not particularly limited. As an example, the conversion unit 25 converts each of a plurality of words included in the answer sentence into a plurality of vectors using the vector conversion model and summarizes and converts the plurality of vectors into feature vectors. The vector conversion model is a machine learning model trained to input an answer sentence and output a feature vector corresponding to the answer sentence. As the vector conversion model, Sentence-bert (Reimers, Nils, and Iryna Gurevych. “Sentence-bert: Sentence embeddings using siamese bert-networks.” arXiv preprint arXiv:1908.10084 (2019)) can be used. Sentence-bert includes a BERT block that converts each of a plurality of words included in an answer sentence into a plurality of vectors, and a pooling layer that summarizes the plurality of vectors and converts them into feature vectors. According to this method, it is possible to generate a feature vector reflecting the context of the intermediate feature or the like. The vector conversion model is also an example of the large language model.

The correspondence between the answer sentence and the feature vector can be designed in various ways. As a first method, in a case where a plurality of answer sentences related to a plurality of intermediate features is generated, the conversion unit 25 may concatenate the plurality of answer sentences to generate a single answer sentence, and vectorize the single answer sentence to generate a feature vector. According to the first method, it is possible to convert the features of all the answer sentences from the answer sentence generative model into vectors.

As a second method, in a case where a plurality of answer sentences related to a plurality of intermediate features is generated, the conversion unit 25 may generate a plurality of vectors respectively corresponding to the plurality of answer sentences, and concatenate (concat) the plurality of vectors to generate a single feature vector. For example, in a case where three three-dimensional vectors of (0.1,0.3,0.5), (0.2,0.35,0.45), and (0.6,0.2,0.3) are generated, the feature vector is one nine-dimensional vector of (0.1,0.3,0.5,0.2,0.35,0.45,0.6,0.2,0.3). According to the second method, it is possible to reflect a difference in prediction of each intermediate feature in the feature vector.

As a third method, in a case where a plurality of answer sentences related to a plurality of intermediate features is generated, the conversion unit 25 may generate a plurality of vectors respectively corresponding to the plurality of answer sentences and add the plurality of vectors to generate a single feature vector. For example, in a case where three three-dimensional vectors of (0.1,0.3,0.5), (0.2,0.35,0.45), and (0.6,0.2,0.3) are generated, the feature vector is one three-dimensional vector of (0.9,0.85,1.25). According to the third method, it is possible to reduce the number of dimensions of the feature vector as compared with the second method, and it is possible to expect reduction in calculation amount.

The method of conversion into the feature vector is not limited only to the method using the vector conversion model. As another example, the conversion unit 25 may generate a vector in which the number of appearances of each of a plurality of words included in the answer sentence is arranged as the feature vector. According to this method, it is possible to reduce the amount of calculation of process for generating the feature vector.

Once step SA6 is performed, the estimation unit 26 estimates the estimation target based on the feature vector generated in step SA6 (step SA7). In step SA7, as an example, the estimation unit 26 inputs the feature vector to the product estimation model and outputs a text representing a product to be purchased in future which is the estimation target. The feature vector is used, for example, as an initial feature of the user. A transformer or a graph neural network is used as the product estimation model. As the transformer, for example, a method described in Gabriel de Souza Pereira Moreira et al. “Transformers4Rec: Bridging the Gap between NLP and Sequential/Session-Based Recommendation”, ACM Conference on Recommender Systems (2021) can be used. As the graph neural network, for example, a method described in Xiangnan He et al. “LightGCN: Simplifying and Powering Graph Convolution Network for Recommendation”, International ACM SIGIR Conference on Research and Development in Information Retrieval (2020) can be used.

Sequential/Session-Based Recommendation”, ACM Conference on Recommender Systems (2021) can be used. As the graph neural network, for example, a method described in Xiangnan He et al. “LightGCN: Simplifying and Powering Graph Convolution Network for Recommendation”, International ACM SIGIR Conference on Research and Development in Information Retrieval (2020) can be used.

Once step SA7 is performed, the display control unit 27 displays the estimation target output in step SA7 (step SA8). In step SA8, the display control unit 27 displays a text representing the estimation target on the display device 14. The layout of the display screen for the estimation target can be arbitrarily designed.

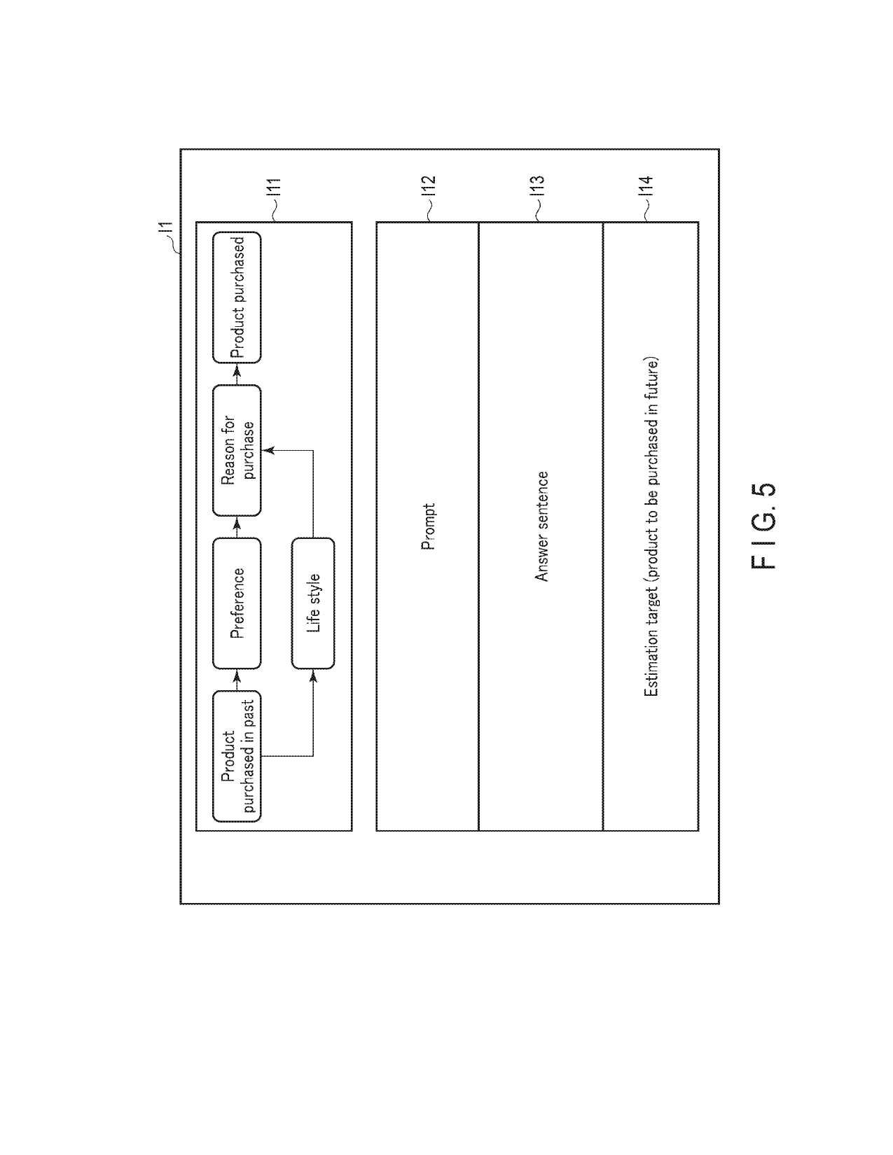

FIG. 5 is a diagram showing an example of a display screen I1 of an estimation target. As shown in FIG. 5, the display screen I1 includes display regions I11 to I14. In the display region I11, a schematic diagram of the association graph input in step SA2 is displayed. The prompt generated in step SA4 is displayed in the display region I12. The answer sentence generated in step SA5 is displayed in the display region I13. In the display region I14, the text representing the product to be purchased in future, which is the estimation target, generated in step SA7 is displayed.

The display screen I1 may be displayed from the start of step SA1. As an example, the display control unit 27 displays the prompt and the answer sentence generated in steps SA4 to SA5 on the display device 14 in an interactive manner. It is preferable that the prompt and the answer sentence be displayed immediately. At this time, the display control unit 27 preferably emphasizes the text corresponding to the attribute information and the text corresponding to the intermediate feature category which are included in the prompt with different visual effects. For example, the text corresponding to the attribute information and the text corresponding to the intermediate feature category may be displayed in different colors, such as blue for the text corresponding to the attribute information and green for the text corresponding to the intermediate feature category. As another example, the text corresponding to the attribute information and the text corresponding to the intermediate feature category may be emphasized by display in different fonts or sizes, presence or absence of underline, and the like. The display control unit 27 may display the association graph side by side with the prompt and the answer sentence. At this time, the display control unit 27 may emphasize the attribute category, the intermediate feature category, and the estimation target category with different visual effects. By displaying the association graph, the user can grasp the association relationship of the intermediate features such as “preference”, “lifestyle”, and “reason for purchase” displayed in the display regions I12 and I13. By displaying these prompts, answer sentences, association graphs, and the like, the user can gauge the reliability of the estimation target.

Note that the estimation process shown in FIG. 3 is an example, and any process can be added, deleted, and/or changed without departing from the gist of the invention. As an example, in the above embodiment, the intermediate feature category is extracted from the association graph, but the intermediate feature input unit 22 may directly input the intermediate feature category without using the association graph. As another example, the estimation target is displayed in the above embodiment, but is not necessarily displayed.

As another example, the question generation unit 23 may generate the prompt sequentially from the intermediate feature category corresponding to the intermediate node close to the start point node in the association graph among the intermediate feature categories input by the intermediate feature input unit 22. In this case, the question generation unit 23 generates a prompt regarding the intermediate feature category corresponding to an intermediate node to be generated in the prompt based on the attribute information, the intermediate feature category corresponding to the intermediate node to be generated, and the answer sentence predicting an intermediate feature corresponding to another intermediate node upstream of the intermediate node to be generated. Note that “upstream” means the side of a start point node. For example, in a case where the intermediate feature category corresponding to the generation target intermediate node is the “reason for purchase” in FIG. 2, a prompt regarding the “reason for purchase” is generated based on the attribute information, the intermediate feature category the “reason for purchase”, and the answer sentence of the intermediate feature category “preference” and the answer sentence of the “lifestyle”. According to the present embodiment, it is possible to generate an answer sentence for an intermediate feature category on the downstream side on the premise of the answer sentence for the intermediate feature category on the upstream side of the associative relationship. Therefore, it is expected that the estimation accuracy of the feature vector and the estimation target is improved.

As described above, the information processing apparatus 1 according to the first embodiment includes an attribute input unit 21, an intermediate feature input unit 22, a question generation unit 23, an answer sentence generation unit 24, and a conversion unit 25. The attribute input unit 21 inputs attribute information that is entity information of an attribute category related to a process target. The intermediate feature input unit 22 inputs at least one intermediate feature category related to an intermediate feature that can be associated with an estimation target that is associated with the attribute information and is entity information of the estimation target category. The question generation unit 23 generates a prompt representing a question sentence to a large language model (LLM) related to the intermediate feature category based on the intermediate feature category and the attribute information. The answer sentence generation unit 24 applies the prompt to the large language model to generate an answer sentence predicting the intermediate feature. The conversion unit 25 converts the answer sentence into a vector and converts the vector into a feature vector.

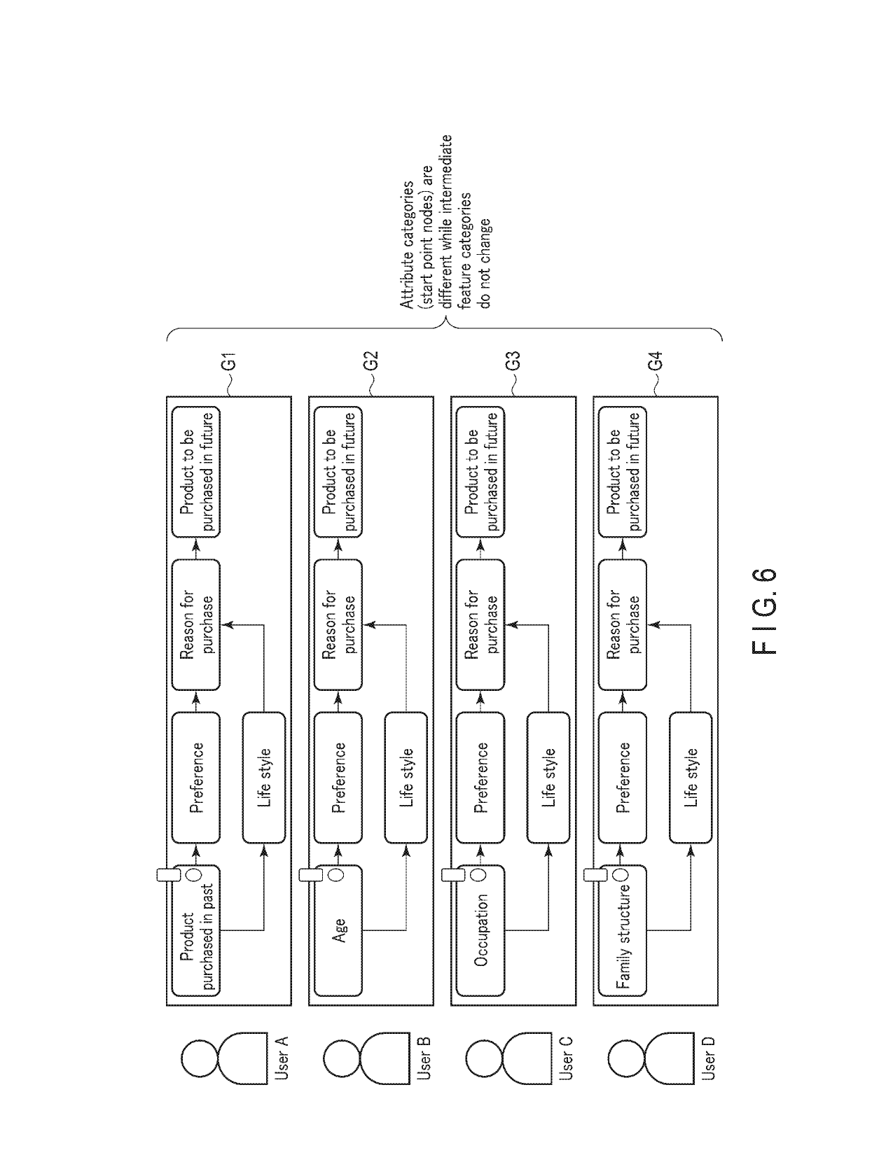

Here, effects according to the first embodiment will be described with reference to FIG. 6. FIG. 6 is a diagram schematically showing differences in attribute information among a plurality of users (USER A, B, C, and D) and a fact that intermediate features are common regardless of the differences. As described above, in the first embodiment, the estimation target is not directly estimated from the attribute information, but the estimation target is estimated from one or more intermediate features associated from the attribute information. The intermediate feature category is associated with the attribute category, but is fixed regardless of the attribute category. For example, in FIG. 6, the attribute category “product purchased in the past” is input to the user A, the attribute category “age” is input to the user B, the attribute category “occupation” is input to the user C, and the attribute category “family structure” is input to the user D, but the intermediate feature categories are fixed by “preference”, “lifestyle”, and “reason for purchase” for any user. As described above, even in a case where the attribute categories input among the plurality of users are different, it is possible to generate an effective prompt for estimating the estimation information from the intermediate features related to the same intermediate feature category. In other words, since it is possible to generate a prompt regardless of the attribute category of the input attribute information, it is possible to easily generate a prompt and a feature vector based on the prompt. In addition, it is also possible to equalize the accuracy of the prompt and the feature vector and improve the reliability of the prompt.

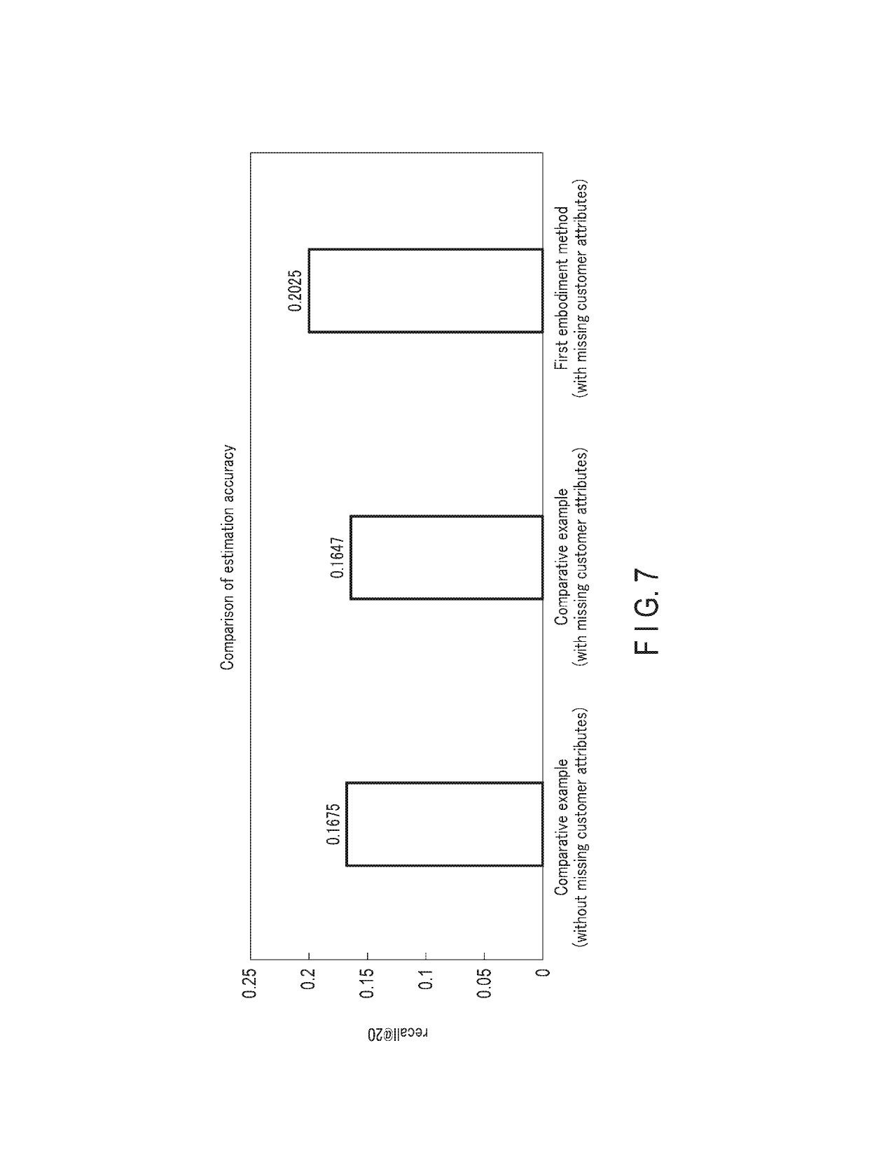

FIG. 7 is a diagram for comparing estimation accuracy (recall) between the method according to the first embodiment and the method according to a comparative example. The vertical axis represents recall (recall@20) which is a type of estimation accuracy. In the comparative example, a product to be purchased in future is directly estimated from customer information as attribute information. The attribute information is a gender, a family structure, an occupation, an annual income, and a product purchased in the past. In the comparative example (without missing customer attributes), estimation was performed using all the attribute information described above. In the comparative example (with missing customer attributes), attribute information other than the product purchased in the past is lost. That is, in the comparative example (with missing customer attributes), the product to be purchased in future is directly estimated from the text representing the product purchased in the past. In the method of the first embodiment, a text indicating an intermediate feature is generated from the product purchased in the past, and the product to be purchased in future is estimated from the text. In both the comparative example and the first embodiment, Transformers4rec was used as an algorithm for estimating the product to be purchased in future from text. As shown in FIG. 7, in the comparative example (with missing customer attributes), the recall is slightly lower than that in the comparative example (without missing customer attributes). In the method of the first embodiment (with missing customer attributes), the recall is improved as compared with the comparative example (with missing customer attributes).

Note that, in the above embodiment, only any one category of “gender”, “family structure ”, “occupation”, “annual income”, “product purchased in the past”, and the like has entity information, and the intermediate feature input unit 22 inputs only attribute information of the one category. However, the present embodiment is not limited thereto. In a case where entity information exists for two or more attribute categories among the plurality of attribute categories, the intermediate feature input unit 22 may input attribute information related to any one attribute category among the two or more attribute categories. As another example, all pieces of attribute information of the two or more attribute categories may be input. In this case, an association graph from the two or more attribute categories to the estimation target category via the plurality of intermediate feature categories is created in advance, and the plurality of intermediate feature categories is extracted from the association graph. Subsequent process is similar to steps SA4 to SA8 shown in FIG. 3. As a result, a feature vector or the like can be generated using the attribute information of two or more attribute categories.

Thus, according to the present embodiment, a feature vector representing a process target such as a user or an item can be easily generated using a large language model.

### Second Embodiment

An information processing apparatus according to a second embodiment uses only some of the intermediate feature categories included in the association graph. Hereinafter, the information processing apparatus according to the second embodiment will be described. Note that, in the following description, components having substantially the same functions as those of the first embodiment will be denoted by the same reference numerals, and redundant description will be given only when necessary.

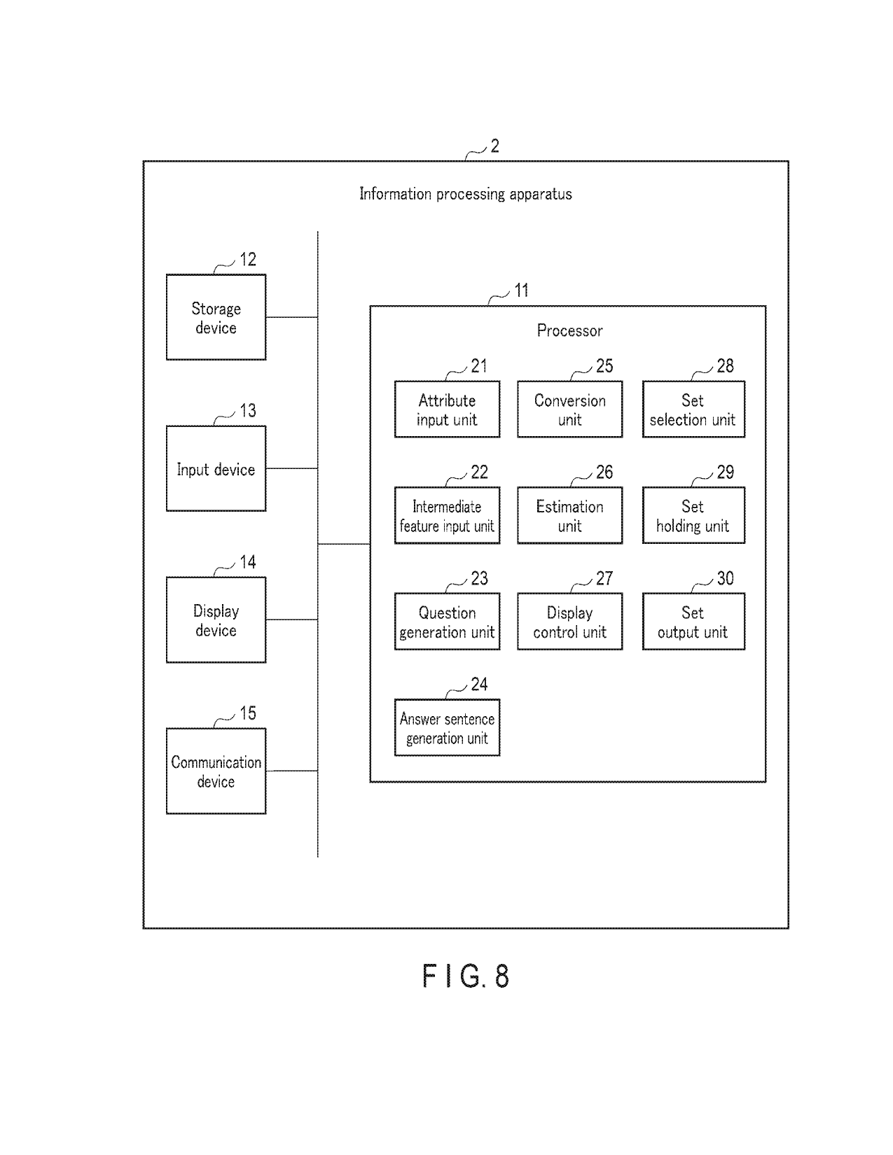

FIG. 8 is a diagram showing a configuration example of an information processing apparatus 2 according to the second embodiment. As shown in FIG. 8, a processor 11 according to the second embodiment includes, in addition to an attribute input unit 21, an intermediate feature input unit 22, a question generation unit 23, an answer sentence generation unit 24, a conversion unit 25, an estimation unit 26, and a display control unit 27, a set selection unit 28, a set holding unit 29, and a set output unit.

The set selection unit 28 selects a plurality of intermediate feature category sets that is a combination of all or some of the intermediate feature categories input by the intermediate feature input unit 22. The intermediate feature category set includes one or more intermediate feature categories. The set holding unit 29 holds each of the plurality of intermediate feature category sets selected by the set selection unit 28 in association with the estimation accuracy. The estimation accuracy means the accuracy of the estimation target measured by the estimation unit 26 for each intermediate feature category set. The intermediate feature category set and the estimation accuracy are stored in the storage device 12 in association with each other. The set output unit 30 outputs the intermediate feature category set with which the estimation accuracy is not associated in a case where there is the intermediate feature category set with which the estimation accuracy is not associated among the plurality of intermediate feature category sets selected by the set selection unit 28, and outputs the intermediate feature category set with the highest estimation accuracy in a case where there is no intermediate feature category set with which the estimation accuracy is not associated. Process of steps SA4 to SA8 according to the first embodiment is executed for the output intermediate feature category set.

Next, an example of recording process of estimation accuracy for each intermediate feature category set by the information processing apparatus 2 according to the second embodiment will be described.

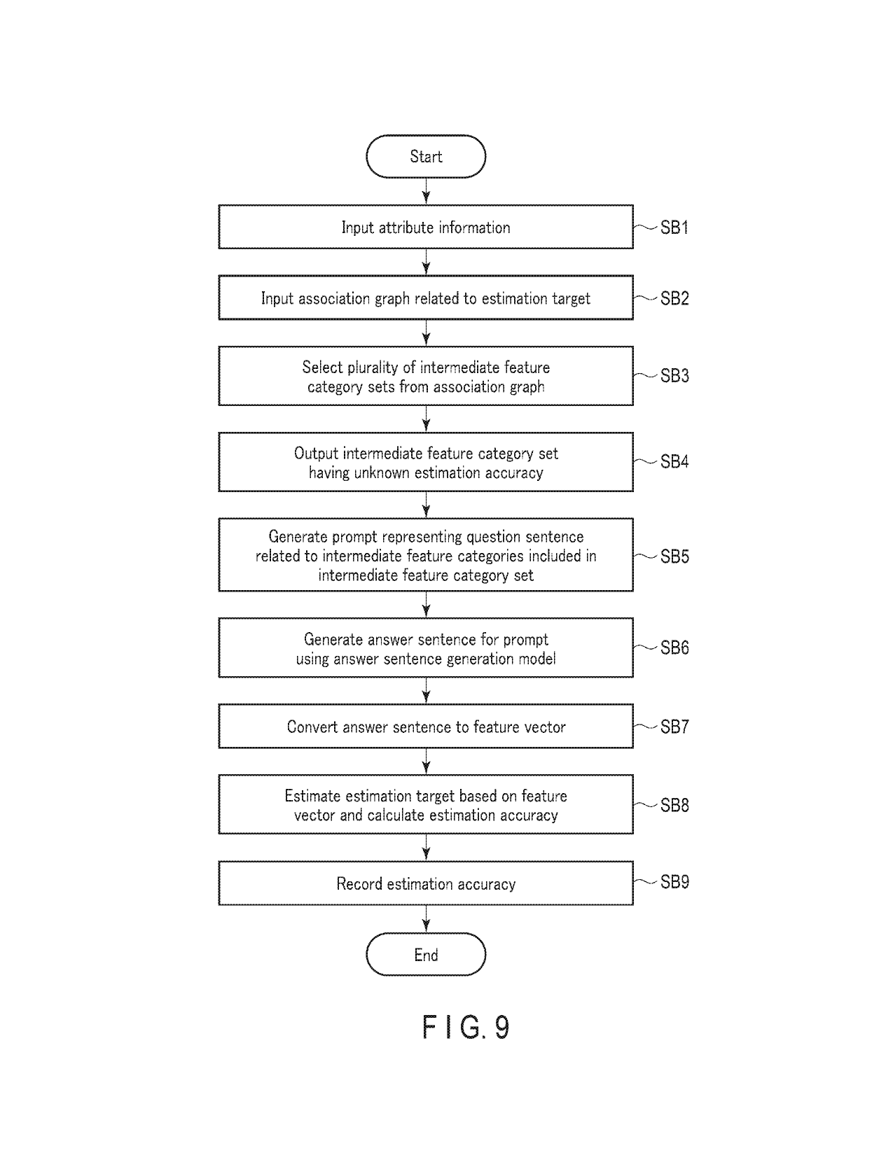

FIG. 9 is a diagram showing an example of recording process of estimation accuracy for each intermediate feature category set by the information processing apparatus 2 according to the second embodiment. Note that, in FIG. 9, it is assumed that a process target is a user. The recording process shown in FIG. 9 is executed in a situation where the estimation accuracy is not recorded for the intermediate feature category set related to the intermediate feature category constituting an association graph, for example, when the association graph to be used is used for the first time. Steps SB1 to SB2 are similar to steps SA1 to SA2 shown in FIG. 3.

Once step SB2 is performed, the set selection unit 28 selects the plurality of intermediate feature category sets from the association graph input in step SB2 (step SB3). As an example, the set selection unit 28 extracts all the intermediate feature categories from the association graph and generates all combinations including one or more of the extracted intermediate feature categories. One combination corresponds to one intermediate feature category set. The intermediate feature category set is recorded in a table (hereinafter, referred to as a set table.) such as a look up table (LUT) in association with the estimation accuracy. The set table is stored in the storage device 12.

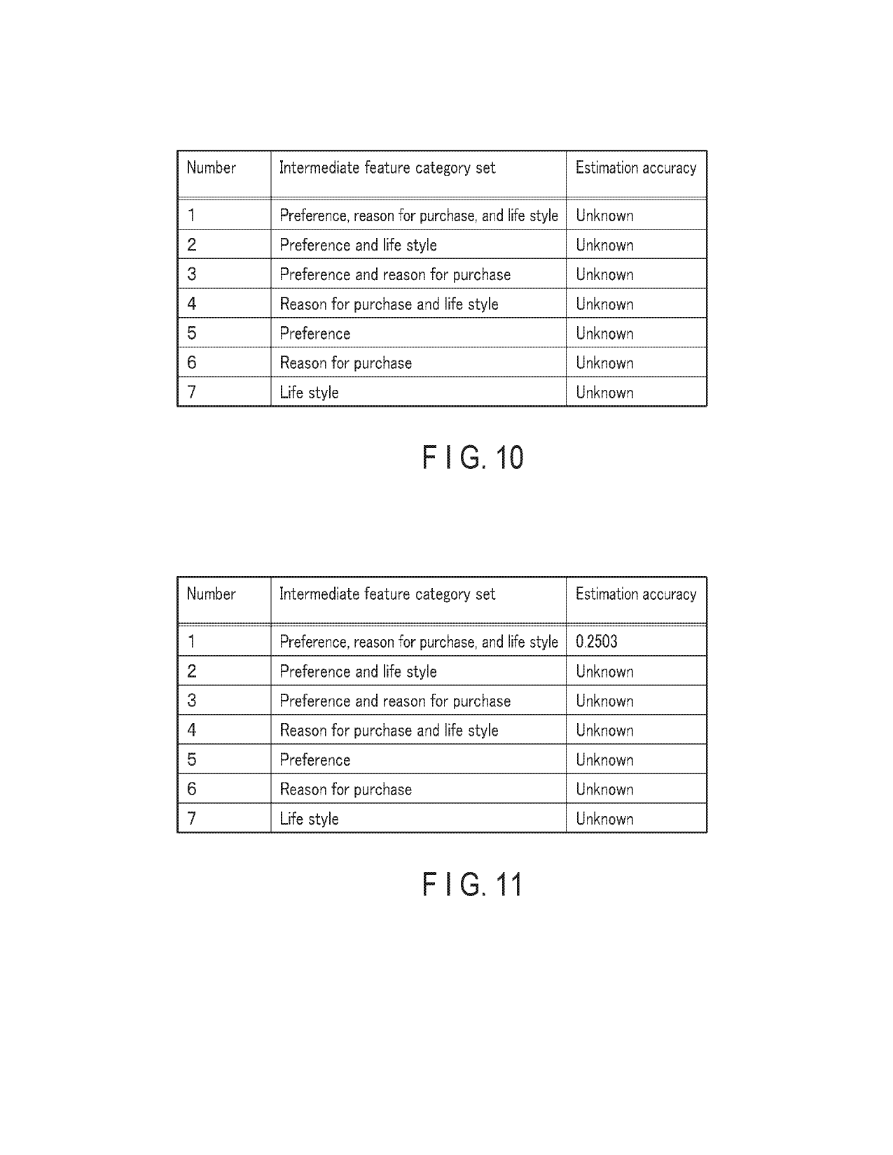

FIG. 10 is a diagram showing a set table related to the association graph shown in FIG. 2. Note that, for the sake of illustration, it is assumed that the estimation accuracy is not measured for all the intermediate feature category sets, and therefore “unknown” is registered in the fields of all the estimation accuracy. Since the intermediate feature categories included in the association graph shown in FIG. 2 are “preference”, “reason for purchase”, and “lifestyle”, seven intermediate feature category sets of (preference, reason for purchase, and lifestyle), (preference and lifestyle), (preference and reason for purchase), (reason for purchase and lifestyle), (preference), (reason for purchase), and (lifestyle) are selected.

Once step SB3 is performed, the set output unit 30 outputs an intermediate feature category set with unknown estimation accuracy from among the number of intermediate feature category sets selected in step SB3 (step SB4). In a case where there is a plurality of intermediate feature category sets with unknown estimation accuracy, the set output unit 30 may output all the intermediate feature category sets with unknown estimation accuracy or may output some of the intermediate feature category sets. In a case where some of the intermediate feature category sets are output, the set output unit 30 may select the intermediate feature category sets randomly or according to a predetermined rule or may select the intermediate feature category sets according to an instruction of an operator via the input device 13.

Once step SB4 is performed, the question generation unit 23 generates a prompt representing a question sentence related to each of the intermediate feature categories included in the intermediate feature category set output in step SB4 (step SB5). Step SB5 is similar to step SA4.

Once step SB5 is performed, steps SB6 to SB7 are performed similarly to steps SA5 to SA6. Once step SB7 is performed, the estimation unit 26 estimates the estimation target based on the feature vector generated in step SB7 (step SB8). The estimation process of the estimation target is executed for each intermediate feature category set. Note that the estimation unit 26 calculates the estimation accuracy after the estimation process of the estimation target. As the estimation accuracy, specifically, any index such as recall, precision, and accuracy may be used.

Once step SB8 is performed, the set holding unit 29 records the estimation accuracy calculated in step SB8 (step SB9). Specifically, the set holding unit 29 records the calculated numerical value of the estimation accuracy in the corresponding field of the corresponding intermediate feature category set in the set table.

FIG. 11 is a diagram showing an example of a set table in which estimation accuracy is recorded. The set table in FIG. 11 corresponds to the set table in FIG. 10. As shown in FIG. 11, in a case where the estimation accuracy of the intermediate feature category set with the number 1 (preference, reason for purchase, and lifestyle) is calculated, a numerical value of the estimation accuracy such as “0.2503” is recorded in the estimation accuracy field of the intermediate feature category set.

As described above, the recording process of the estimation accuracy for each intermediate feature category set ends.

In the first embodiment, all the intermediate feature categories included in the association graph are used. However, some of the intermediate feature categories do not contribute to estimation or may deteriorate estimation accuracy. With the recording process described above, it is possible to grasp the intermediate feature category set with the highest estimation accuracy. In the case that the estimation process of the product to be purchased in future is performed using the same association graph after the end of the recording process in FIG. 10, the set output unit 30 outputs the intermediate feature category set having the highest estimation accuracy among the plurality of intermediate feature category sets related to the association graph. Thereafter, a prompt is generated for the output intermediate feature category set, a feature vector is generated using the prompt, and a product purchased is estimated based on the feature vector. As described above, the feature vector generation and the estimation of a product purchased can be performed using the combination of the intermediate feature categories with the highest estimation accuracy, so that the accuracy of the feature vector and the product purchased can be improved.

Note that the recording process shown in FIG. 9 is an example, and any process can be added, deleted, and/or changed without departing from the gist of the invention.

As an example, in the above embodiment, the intermediate feature category set and the estimation accuracy are held for each association graph, but the set holding unit 29 may hold the intermediate feature category set and the estimation accuracy for each estimation algorithm of the estimation target. As a result, it is possible to obtain a highly accurate feature vector and a product purchased by using an optimum intermediate feature category set for each estimation algorithm.

As another example, the intermediate feature input unit 22 may input at least one intermediate feature category set that is a combination of intermediate feature categories. That is, the intermediate feature input unit 22 inputs not all the intermediate feature category sets including the plurality of intermediate feature categories included in the association graph, but only the predetermined intermediate feature category set. The set holding unit 29 holds the input intermediate feature category set and the estimation accuracy in association with each other. The set output unit 30 outputs the intermediate feature category set with which the estimation accuracy is not associated in a case where there is the intermediate feature category set with which the estimation accuracy is not associated among the intermediate feature category sets, and outputs the intermediate feature category set with the highest estimation accuracy in a case where there is no intermediate feature category set with which the estimation accuracy is not associated. The question generation unit 23 generates an answer sentence for the intermediate feature category included in the output intermediate feature category set. Thereafter, as in the above-described embodiment, a feature vector is generated based on the answer sentence, and the product purchased is estimated based on the feature vector. As described above, the feature vector generation and the estimation of a product purchased can be performed using the combination of the intermediate feature categories with the highest estimation accuracy, so that the accuracy of the feature vector and the product purchased can be improved.

### Third Embodiment

An information processing apparatus according to a third embodiment uses an answer sentence generative model with high estimation accuracy among a plurality of answer sentence generative models. Hereinafter, the information processing apparatus according to the third embodiment will be described. Note that, in the following description, components having substantially the same functions as those of the first embodiment will be denoted by the same reference numerals, and redundant description will be given only when necessary.

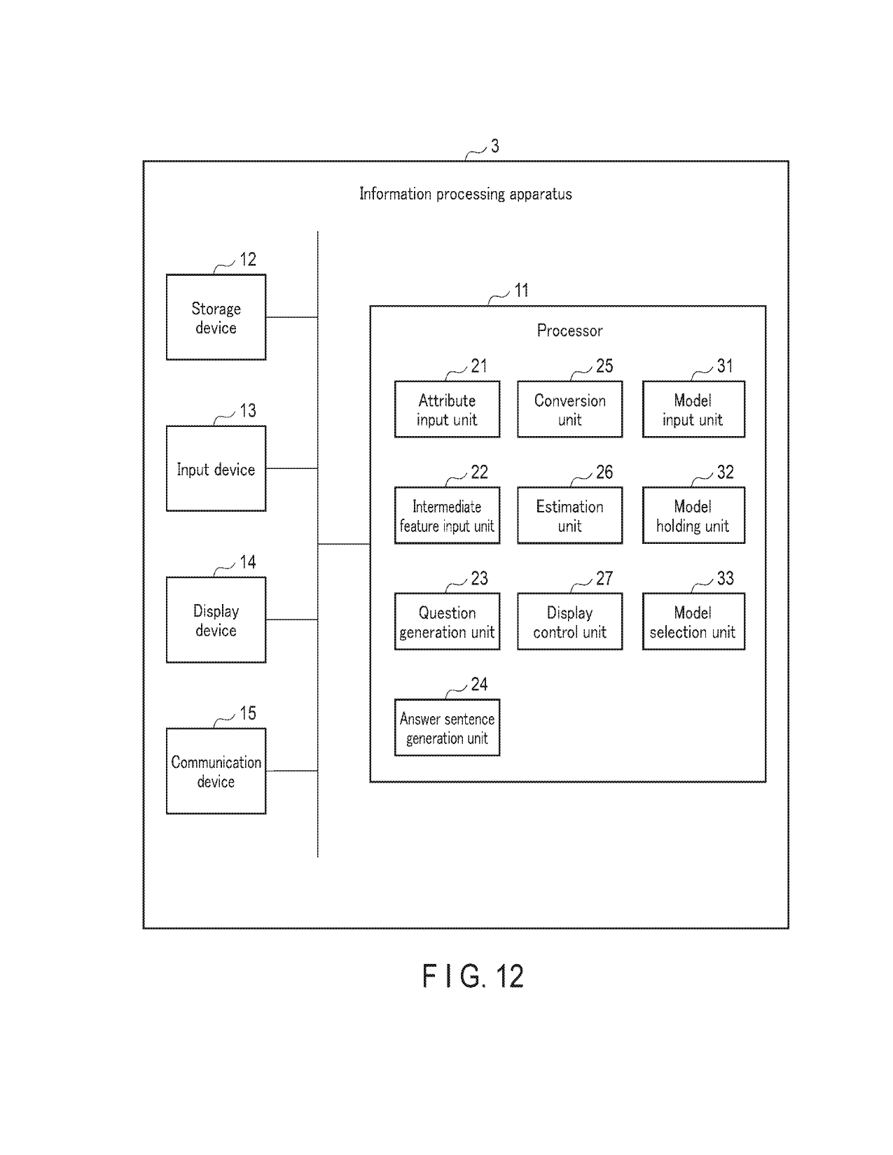

FIG. 12 is a diagram showing a configuration example of an information processing apparatus 3 according to the third embodiment. As shown in FIG. 12, a processor 11 according to the third embodiment includes, in addition to an attribute input unit 21, an intermediate feature input unit 22, a question generation unit 23, an answer sentence generation unit 24, a conversion unit 25, an estimation unit 26, and a display control unit 27, a model input unit 31, a model holding unit 32, and a model selection unit 33.

The model input unit 31 inputs a plurality of answer sentence generative models. The model holding unit 32 holds each of the plurality of answer sentence generative models input by the model input unit 31 in association with the estimation accuracy. The estimation accuracy means the accuracy of the estimation target measured by the estimation unit 26 for each answer sentence generative model. The answer sentence generative model and the estimation accuracy are stored in the storage device 12 in association with each other. In a case where there is an answer sentence generative model with which the estimation accuracy is not associated among the plurality of answer sentence generative models input by the model input unit 31, the model selection unit 33 selects the answer sentence generative model, and in a case where there is no answer sentence generative model with which the estimation accuracy is not associated, the model selection unit 33 selects the answer sentence generative model with the highest estimation accuracy. Thereafter, the answer sentence generation unit 24 applies the prompt generated by the question generation unit 23 to the large language model selected by the model selection unit 33 to generate an answer sentence predicting the intermediate feature.

Next, an example of recording process of estimation accuracy for each answer sentence generative model by the information processing apparatus 3 according to the third embodiment.

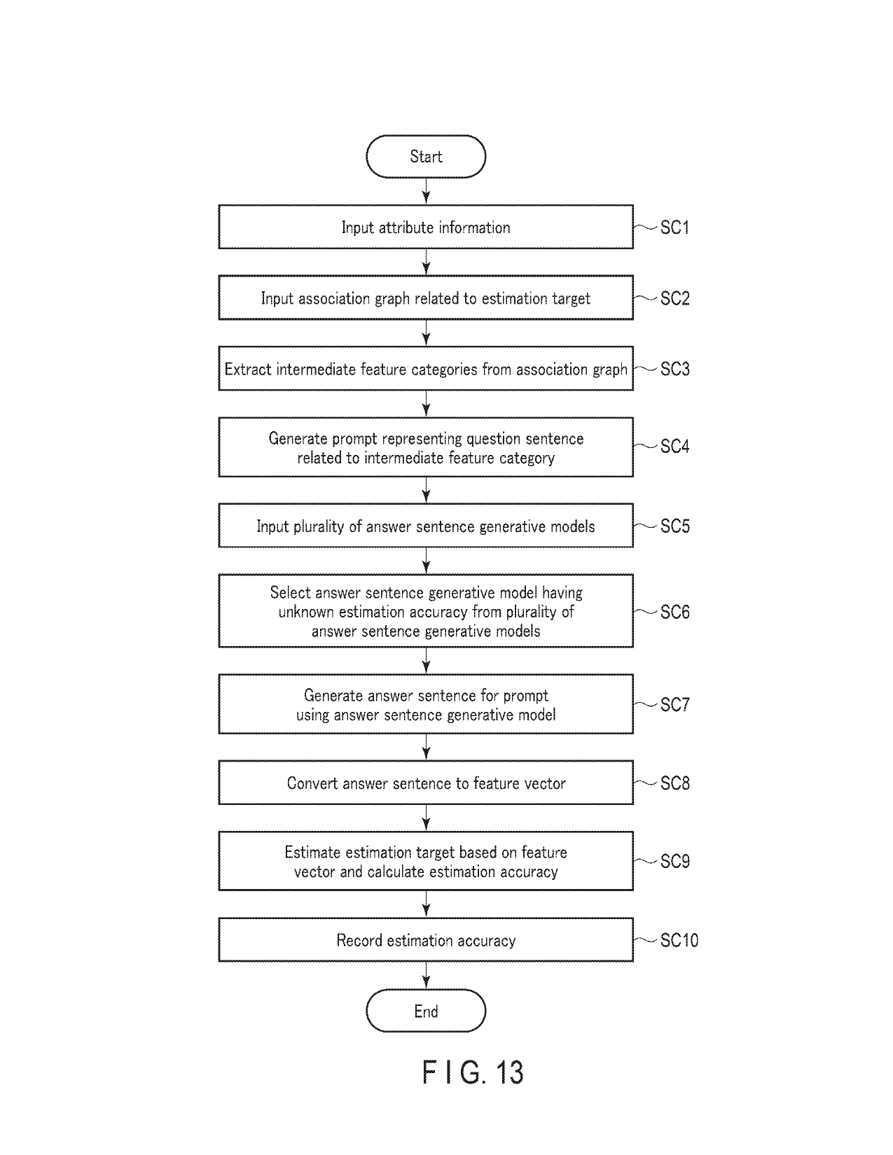

FIG. 13 is a diagram showing an example of recording process of estimation accuracy for each answer sentence generative model by the information processing apparatus 3 according to the third embodiment. Note that, in FIG. 13, it is assumed that a process target is a user. The recording processing shown in FIG. 13 is executed in a situation where the estimation accuracy of the answer sentence generative model is not recorded, for example, when a new answer sentence generative model becomes available for the first time. Steps SC1 to SC4 are similar to steps SA1 to SA4 shown in FIG. 3.

Once step SC4 is performed, the model input unit 31 inputs a plurality of answer sentence generative models (step SC5). The plurality of answer sentence generative models is assumed to have different answer sentence generation algorithms and network structures. Due to these differences, the estimation accuracy of the estimation targets is different. The answer sentence generative model is recorded in a table (hereinafter, referred to as a model table) such as an LUT in association with the estimation accuracy. The model table is stored in the storage device 12.

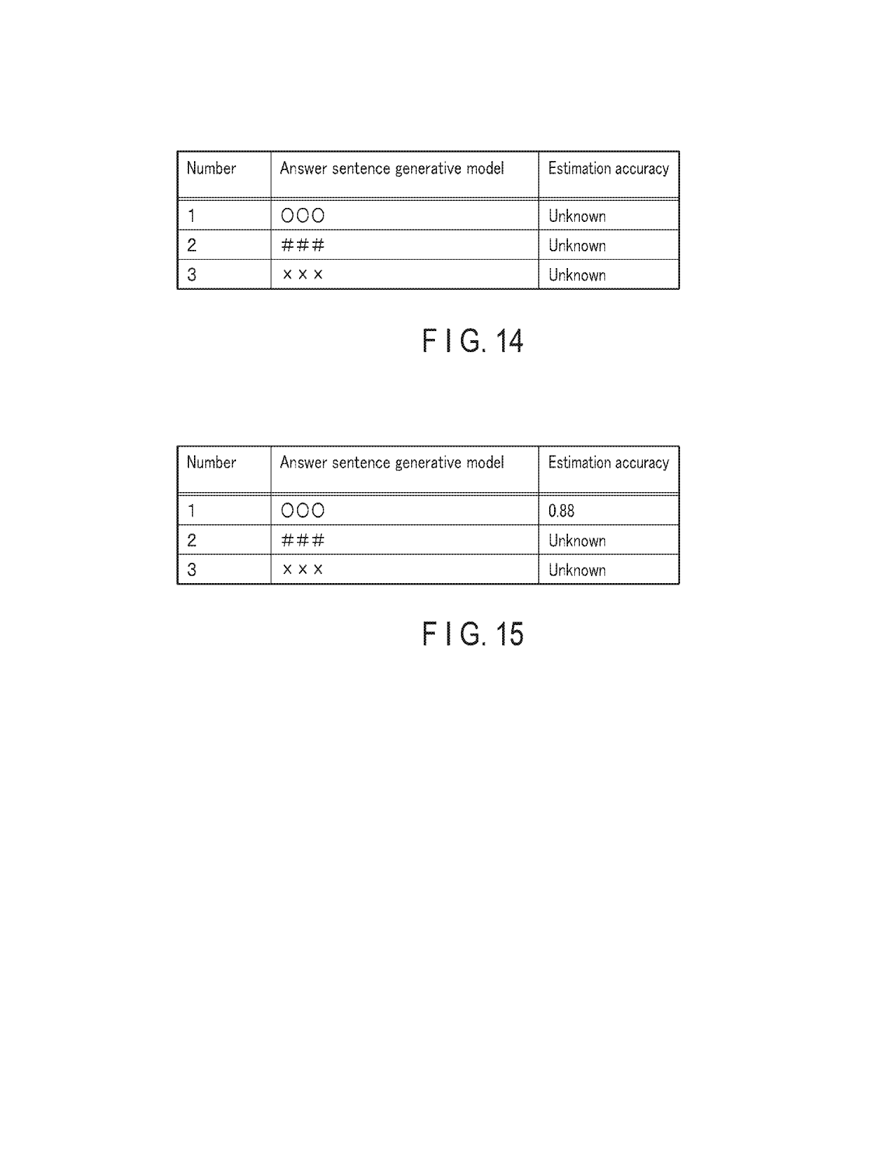

FIG. 14 is a diagram showing the model table. For the sake of illustration, it is assumed that “unknown” is registered in the column of estimation accuracy for all the answer sentence generative models. In the field of the answer sentence generative model, product names such as “○○○”, “###”, and “□□□”, identification numbers, and the like are recorded.

Once step SC5 is performed, the model selection unit 33 selects an answer sentence generative model with unknown estimation accuracy from the plurality of answer sentence generative models input in step SC5 (step SC6). In a case where there is a plurality of answer sentence generative models with unknown estimation accuracy, the model selection unit 33 may select all the answer sentence generative models with unknown estimation accuracy or may select some of the answer sentence generative models. In a case where some of the answer sentence generative models are output, the model selection unit 33 may select the answer sentence generative models randomly or according to a predetermined rule or may select the answer sentence generative models according to an instruction of an operator via the input device 13.

Once step SC6 is performed, the answer sentence generation unit 24 generates an answer sentence to the prompt generated in step SC4 for each answer sentence generative model selected in step SC6 (step SC7). Once step SC7 is performed, the conversion unit 25 converts the answer sentences generated in step SC7 into feature vectors (step SC8). The feature vector is generated for each selected answer sentence generative model. Once step SC8 is performed, the estimation unit 26 estimates the estimation target based on the feature vector generated in step SC8 (step SC9). The estimation process of the estimation target is executed for each answer sentence generative model. Note that the estimation unit 26 calculates any estimation accuracy after the estimation process of the estimation target. As the estimation accuracy, specifically, any index such as recall, precision, and accuracy may be used.

Once step SC9 is performed, the model holding unit 32 records the estimation accuracy calculated in step SC9 (step SC10). Specifically, the model holding unit 32 records the calculated numerical value of the estimation accuracy in the corresponding field of the corresponding answer sentence generative model in the model table.

FIG. 15 is a diagram showing an example of a model table in which estimation accuracy is recorded. The model table of FIG. 15 corresponds to the model table of FIG. 14. As shown in FIG. 15, in a case where the estimation accuracy of the answer sentence generative model “○○○” with the number 1 is calculated, a numerical value of the estimation accuracy such as “0.88” is recorded in the estimation accuracy field of the answer sentence generative model.

As described above, the recording process of the estimation accuracy for each answer sentence generative model ends.

In the first embodiment, a predetermined answer sentence generative model is used. However, under a situation where various answer sentence generative models are provided from various companies, it is desirable to use an answer sentence generative model with high estimation accuracy from among them. With the recording process described above, it is possible to grasp the answer sentence generative model with the highest estimation accuracy. In a case where the estimation process of the product to be purchased in future is performed using the same association graph after the end of the recording process shown in FIG. 13, the model selection unit 33 selects an answer sentence generative model with the highest estimation accuracy among a plurality of answer sentence generative models. Thereafter, an answer sentence is generated using the selected answer sentence generative model, a feature vector is generated based on the answer sentence, and a product purchased is estimated based on the feature vector. As described above, the feature vector generation and the estimation of a product purchased can be performed using the answer sentence generative model with the highest estimation accuracy, so that the accuracy of the feature vector and the product purchased can be improved.

Note that the recording process shown in FIG. 13 is an example, and any process can be added, deleted, and/or changed without departing from the gist of the invention. As an example, the third embodiment may be combined with any process described in the first embodiment and the second embodiment.

Thus, it is possible to provide an information processing apparatus, a method, and a program capable of easily generating a feature vector representing a process target such as a user or an item using a large language model.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for generating feature vector, comprising a processor configured to:
input attribute information that is entity information of an attribute category related to a process target;
input at least an intermediate feature category related to an intermediate feature capable of being associated with an estimation target that is associated with the attribute information and is entity information of an estimation target category;
generate a prompt representing a question sentence to an answer sentence generative model regarding the intermediate feature category based on the intermediate feature category and the attribute information;
apply the prompt to the answer sentence generative model to generate an answer sentence predicting the intermediate feature; and
convert the answer sentence into a feature vector.

2. The apparatus according to claim 1, wherein the processor is further configured to estimate the estimation target based on the feature vector.

3. The apparatus according to claim 2, wherein
the processor is further configured to:
select a plurality of intermediate feature category sets that is a combination of all or some of the input intermediate feature categories;
hold each of the intermediate feature category sets and estimation accuracy in association with each other; and
in a case where there is an intermediate feature category set with which estimation accuracy is not associated among the intermediate feature category sets, output the intermediate feature category set, and in a case where there is no intermediate feature category set with which estimation accuracy is not associated among the intermediate feature category sets, output an intermediate feature category set with highest estimation accuracy, and
the processor generates the answer sentence for the intermediate feature category included in the output intermediate feature category set.

4. The apparatus according to claim 2, wherein
the processor is configured to:
input at least an intermediate feature category set that is a combination of the intermediate feature categories;
hold the intermediate feature category set and estimation accuracy in association with each other;
in a case where there is an intermediate feature category set with which estimation accuracy is not associated among the intermediate feature category sets, output the intermediate feature category set, and in a case where there is no intermediate feature category set with which estimation accuracy is not associated among the intermediate feature category sets, output an intermediate feature category set with highest estimation accuracy; and
generate the answer sentence for the intermediate feature category included in the output intermediate feature category set.

5. The apparatus according to claim 2, wherein
the processor is further configured to:
input a plurality of answer sentence generative models;
store each of the answer sentence generative models and estimation accuracy in association with each other; and
in a case where there is an answer sentence generative model with which estimation accuracy is not associated among the answer sentence generative models, select the answer sentence generative model, and in a case where there is no answer sentence generative model with which estimation accuracy is not associated among the answer sentence generative models, select an answer sentence generative model with the highest estimation accuracy, and
the processor applies the prompt to the selected answer sentence generative model to generate an answer sentence predicting the intermediate feature.

6. The apparatus according to claim 1, wherein in a case where a plurality of answer sentences related to a plurality of intermediate features is generated, the processor concatenates the answer sentences to generate an answer sentence, and converts the answer sentence into a vector to convert the vector into the feature vector.

7. The apparatus according to claim 1, wherein in a case where a plurality of answer sentences related to a plurality of intermediate features is generated, the processor generates a plurality of vectors each corresponding to the answer sentences, and concatenates the vectors to generate the feature vector.

8. The apparatus according to claim 1, wherein in a case where a plurality of answer sentences related to a plurality of intermediate features is generated, the processor generates a plurality of vectors each corresponding to the answer sentences, and adds the vectors to generate the feature vector.

9. The apparatus according to claim 1, wherein the processor converts a plurality of words included in the answer sentence into a plurality of vectors, respectively, and summarizes and converts the vectors into the feature vector.

10. The apparatus according to claim 1, wherein the processor generates, as the feature vector, a vector in which a number of appearances of each of a plurality of words included in the answer sentence is arranged.

11. The apparatus according to claim 1, wherein
the processor
inputs an association graph related to the estimation target category, the association graph including a start point node corresponding to the attribute category, an end point node corresponding to the estimation target category, and an intermediate node corresponding to the intermediate feature category, the nodes in an association relationship among the start point node, the end point node, and the intermediate node being connected by an edge, and
excludes the start point node and the end point node from the association graph to extract the intermediate feature category.

12. The apparatus according to claim 11, wherein the attribute category can be arbitrarily selected from a plurality of predetermined specific categories for each piece of the attribute information.

13. The apparatus according to claim 11, wherein
the attribute category includes at least any of an age, a gender, a family structure, and a product purchased in the past,
the intermediate feature category includes at least any of a preference, a lifestyle, and a reason for purchase,
an input side of an intermediate node corresponding to the preference and an input side of an intermediate node corresponding to the lifestyle are connected in parallel to an output side of the start point node,
an input side of an intermediate node corresponding to the reason for purchase is connected to an output side of an intermediate node corresponding to the preference and an output side of an intermediate node corresponding to the lifestyle in parallel, and
an input side of the end point node is connected to an output side of an intermediate node corresponding to the reason for purchase.

14. The apparatus according to claim 11, wherein the processor generates the prompt sequentially from the intermediate feature category corresponding to the intermediate node close to the start point node in the association graph among the input intermediate feature categories.

15. The apparatus according to claim 14, wherein the processor generates a prompt regarding an intermediate feature category corresponding to an intermediate node to be generated for a prompt in the input intermediate feature categories based on the attribute information, the intermediate feature category corresponding to the intermediate node, and the answer sentence predicting an intermediate feature corresponding to another intermediate node upstream of the intermediate node to be generated.

16. The apparatus according to claim 1, wherein the processor is further configured to display the prompt and the answer sentence on a display device in an interactive manner.

17. The apparatus according to claim 16, wherein the processor emphasizes a text corresponding to the attribute information and a text corresponding to the intermediate feature category included in the prompt with different visual effects.

18. The apparatus according to claim 16, wherein
the processor displays an association graph side by side with the prompt and the answer sentence, and
the association graph includes a start point node corresponding to the attribute category, an end point node corresponding to the estimation target category, and an intermediate node corresponding to the intermediate feature category, and the nodes in an association relationship among the start point node, the end point node, and the intermediate node are connected by an edge.

19. A method of information processing executed by a computer, the method comprising:
inputting attribute information that is entity information of an attribute category related to a process target;
inputting at least an intermediate feature category related to an intermediate feature capable of being associated with an estimation target that is associated with the attribute information and is entity information of an estimation target category;
generating a prompt representing a question sentence to an answer sentence generative model regarding the intermediate feature category based on the intermediate feature category and the attribute information;
applying the prompt to the answer sentence generative model to generate an answer sentence predicting the intermediate feature; and
converting the answer sentence into a feature vector.

20. A non-transitory computer readable medium including computer executable instructions, wherein the instructions, when executed by a processor, cause the processor to perform operations comprising:
inputting attribute information that is entity information of an attribute category related to a process target;
inputting at least an intermediate feature category related to an intermediate feature capable of being associated with an estimation target that is associated with the attribute information and is entity information of an estimation target category;
generating a prompt representing a question sentence to an answer sentence generative model regarding the intermediate feature category based on the intermediate feature category and the attribute information;
applying the prompt to the answer sentence generative model to generate an answer sentence predicting the intermediate feature; and
converting the answer sentence into a feature vector.
